(19) United States
(12) Patent Application Publication
(10) Pub. No.: US 2010/0122955 A1
(43) Pub. Date: May 20, 2010

(54) METHOD AND SYSTEM OF FILTERING OIL

(76) Inventor: Durbin Alan Hartel, Cherokee, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/272,009

(22) Filed: Nov. 17, 2008

(51) Int. Cl. B01D 61/22

(52) U.S. Cl. 210/637; 210/137; 210/88

(57) ABSTRACT

A method and system for filtering oil and the like having a feed tank connected to a cell having a sintered or ceramic module that restricts particles greater than 0.1 microns to seep through. The pressure, temperature, and flow rate of the fluid are selected to create optimum viscosity of the fluid.

### BACKGROUND OF THE INVENTION

This invention is directed to a method and system for filtering oil and petroleum products and more particularly for removing particles down to about 0.1 microns.

Methods and systems for filtering oil and petroleum products are known in the art. While these systems work for their intended purpose, these systems are not effective in removing small particles for filtrate recovery. Part of the reason is that the oil does not have an acceptable viscosity to permit the removal of small particles. Thus, a need exists in the art for a method and system that addresses these deficiencies.

An object of the present invention is to provide a filtering system that removes particles down to about 0.1 microns.

Another object of the present invention is to provide a system that utilizes a sintered module.

A still further objective of the present invention is to provide a system that optimizes the viscosity of the filtered material.

These and other objectives will be apparent to one of skill in the art based upon the following disclosure.

### SUMMARY OF THE INVENTION

A filtering system having a feed tank and output line where the pressure of fluid is sensed within the line and the flow rate adjusted to maintain a selected pressure. The output line extends from the feed tank to a cell. The cell has a pump, flow meter, heater, and sintered or ceramic module. The module is connected to a filtrate tank via a filtrate line and permits fluid having particles of 0.1 microns to seep through to the filtrate line. Fluid having particles greater than 0.1 microns are released from the cell to a feed stock tank.

### BRIEF DESCRIPTION OF THE DRAWINGS

FIG. 1 is a schematic of the oil filtering system; and

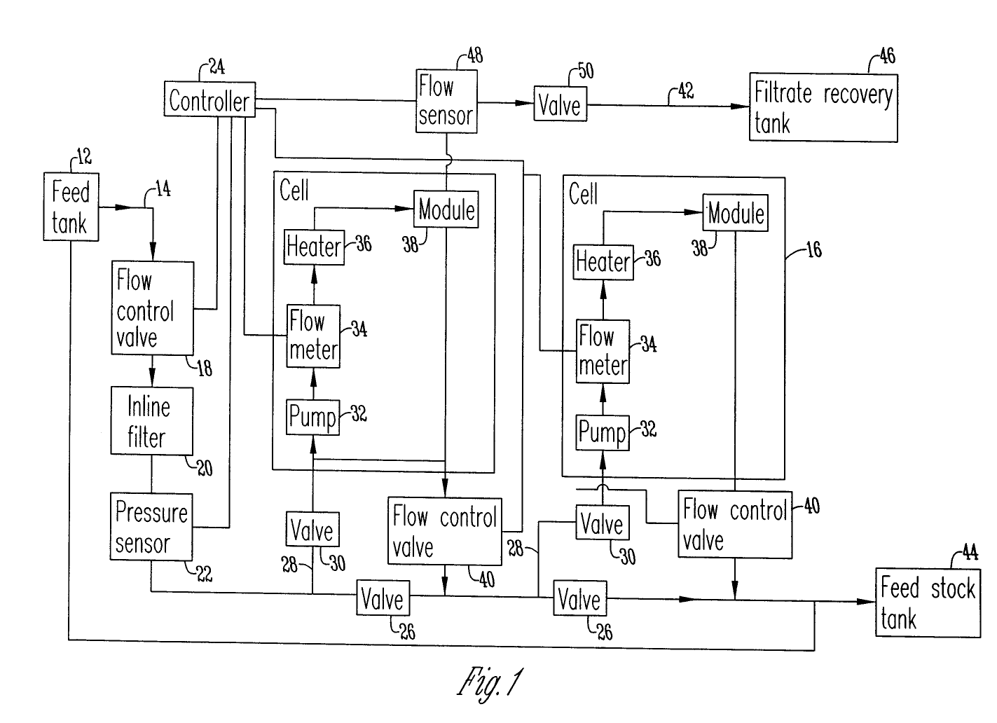

FIG. 2 is a flow diagram of a method for filtering oil.

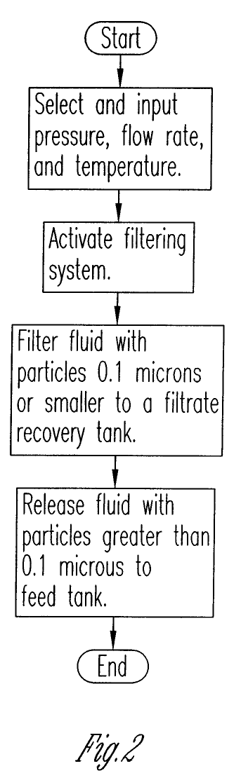

### DETAILED DESCRIPTION OF THE PREFERRED EMBODIMENTS

Referring to the Figures, the system 10 has a feed tank 12. The feed tank 12 contains used oil or petroleum. The feed tank is connected to an output line 14 that extends from the feed tank 12 to a cell 16, or plurality of cells. Operatively connected to the output line 14 is a flow control valve 18, an in-line filter 20, and a pressure sensor 22. Preferably, the in-line filter 20 is a rudimentary 5 micron in-line filter. The flow control valve 18 and the pressure sensor 22 are connected to a controller such that the controller 24 sends a signal to open or close the flow valve 18 based on a signal received from the pressure sensor 22. In this manner, a constant pressure in the output line 14 may be preselected and maintained by the controller 24.

Along the output line 14, and downstream from the pressure sensor 22, are a plurality of shut off valves 26. The shut off valves are normally in a closed position, and are opened to clean or discharge fluid from output line 14. When the shut off valve 26 is closed, flow is diverted from the output line to a cell input line 28.

The cell 16, has a shut off valve 30 that is normally opened except for cleaning or discharge, a pump 32, a flow meter 34, a heater 36, a module 38, and a flow control valve 40. Fluid flows from output line 14 to the pump 32, through the flow meter 34 and the heater 36, to the sintered module 38. Preferably, the sintered module has porous metal filter elements constructed of sintered titanium powder that has exceptional chemical and temperature resistance and can withstand repeated cycles such as the TPM Series Liquid Process Filters manufactured by Graver Technologies. The sintered module 38 is preferably porous at 0.1 micron to permit particles such as dirt, carbon, metallic fibers and the like to seep through to a filtrate line 42. Alternatively, the module is made of a ceramic material.

The fluid, with particles greater than 0.1 microns, flows to flow control valve 40. The flow meter 34 and flow control valve 40 are connected to the controller 24 such that the flow control valve 40 is opened and closed by the controller 24, based on a signal from the flow meter 34. When closed, or partially closed, the flow control valve 40 diverts all or some fluid back to pump 32 where the fluid is recirculated through the cell 16. To the extent that flow control valve 40 is open, or partially open, some or all fluid flows back to output line 14 downstream from shut off valve 26. From cell 16, fluid flows either to subsequent cells, where the process is repeated, to a feed stock tank 44, or back to feed tank 12.

The filtrate line 42 extends from module 38 to a filtrate recovery tank 46. The filtrate line has a flow sensor 48 that is connected to the controller 24. A shut off valve 50 is also connected to the filtrate line 42 and is normally open except for cleaning and discharge.

To optimize the filtering, the fluid should have a desirable viscosity. The viscosity of the fluid is dependent upon the rate of flow, the pressure, and the temperature of the fluid. Preferably, the pressure in lines 14, 28 and 42 should range between 28 to 40 PSI. The temperature of the fluid should range between 340 to 360 degrees F. without exceeding 360° F. The rate of flow should range between 1.5 to 3.2 lbs/hr per sq. ft. Optimally the flow rate should be between 1.8 and 2.3 lbs/hr per sq. ft.

In operation, the pressure, flow rate, and desired temperature are selected and input into the system. Once inputted, the system is activated such that fluid flows from feed tank 12 to cell 16. The pressure in line 14 is maintained at the selected rate based on a signal from pressure sensor 22 which controls flow valve 18 via controller 24. Within the cell, fluid having particles 0.1 microns or smaller are removed through the sintered module 38 to a filtrate tank 46 through a filtrate line 42. Fluid having particles greater than 0.1 microns recirculates within cell 16 until the fluid is released by flow valve 40 based on the rate of flow determined by the flow meter 34. Once released, fluid flows to other cells for subsequent filtering, to a stock feed tank 44, or back to feed tank 12.

Thus a method and system of filtering oil has been disclosed that at the very least meets all of the stated objectives.

What is claimed is:

1. A system for filtering oil and the like, comprising:
a feed tank containing fluid;
a cell having a sintered module for filtering the fluid;
an output line having a flow control valve and a pressure sensor, the line extending from the feed tank to the cell.

2. The system of claim 1 wherein the sintered module is connected to a cell line having a pump, a flow meter, and a heater connected to the cell line.

3. The system of claim 1 wherein the sintered module permits particle 0.1 microns or less to seep through to a filtrate line.

4. The system of claim 1 where the pressure in the output line is between 28 and 40 PSI.

5. The system of claim 2 wherein the flow rate in the output line and cell line is between 1.5 and 3.2 pounds per hour per square foot.

6. The system of claim 2 wherein the flow rate in the output line and cell line is between 1.8 and 2.3 pounds per hour per square foot.

7. The system of claim 2 wherein the fluid temperature is between 340° F. and 360° F.

8. A method of filtering oil or the like, comprising the steps of:
selecting and inputting a pressure, flow rate and temperature into a filtering system;
activating the flow of fluid from a feed tank having a cell with a module;
removing fluid having particles of 0.1 microns or less from the cell through the module to a filtrate tank.

9. The method of claim 8 wherein the pressure selected is between 28 and 40 PSI.

10. The method of claim 8 wherein the selected flow rate is between 1.5 and 3.2 pounds per hour per square foot.

11. The method of claim 8 wherein the selected flow rate is between 1.8 and 2.3 pounds per hour per square foot.

12. The method of claim 8 wherein the selected temperature is between 340° F. and 360° F.

13. The method of claim 8 wherein the module is sintered.

14. The method of claim 8 wherein the module is ceramic.

15. A system for filtering oil and the like, comprising: a feed tank containing fluid;
a cell having a ceramic module for filtering the fluid;
an output line having a flow control valve and a pressure sensor, the line extending from the feed tank to the cell.

16. The system of claim 1 wherein the ceramic module is connected to a cell line having a pump, a flow meter, and a heater connected to the cell line.

17. The system of claim 1 wherein the ceramic module permits particle 0.1 microns or less to seep through to a filtrate line.

18. The system of claim 1 where the pressure in the output line is between 28 and 40 PSI.

19. The system of claim 2 wherein the flow rate in the output line and cell line is between 1.5 and 3.2 pounds per hour per square foot.

20. The system of claim 2 wherein the flow rate in the output line and cell line is between 1.8 and 2.3 pounds per hour per square foot.

21. The system of claim 2 wherein the fluid temperature is between 340° F. and 360° F.
